(19) United States
(12) Patent Application Publication
(10) Pub. No.: US 2006/0000934 A1
(43) Pub. Date: Jan. 5, 2006

(54) Bait casting reel

(76) Inventor: Kwang Ho Hyun, Buchun-City (KR)

Correspondence Address: ST. ONGE STEWARD JOHNSTON & REENS, LLC, 986 BEDFORD STREET, STAMFORD, CT, 06905-5619, US

(21) Appl. No.: 10/885,418

(22) Filed: Jul. 6, 2004

(30) Foreign Application Priority Data
Jul. 4, 2004 (KR) 2003-21433

(51) Int. Cl. A01K 89/00

(52) U.S. Cl. 242/259

(57) ABSTRACT

Disclosed is a bait casting reel capable of preventing abrasion of frictional surfaces of pinion and yoke which are to control transfer of rotatory force from a spool shaft to: improve durableness of the bait casting reel and prevent malfunction thereof. The bait casting reel includes a metal insert coupled to an upper surface of the yoke to prevent the yoke from being worn, in which the upper surface contacted with the pinion.

This application claims priority of pending Korean Patent Application No. 2003-21433 filed Jul. 4, 2003.

### FIELD OF THE INVENTION

The present invention relates to a fishing reel, and more particularly, to a bait casting reel capable of preventing abrasion of frictional surfaces of pinion and yoke which are to control transfer of rotatory force from a spool shaft to improve durableness of the bait casting reel and prevent malfunction thereof.

### BACKGROUND OF THE INVENTION

Bait casting reels used in fly fishing include a body, a spool around which a fishing line is wound, a handle, and a drag knob for controlling transfer of rotatory force from the handle to the spool.

The construction and operation of the bait casting reel are widely known in the art, and thus the detailed description thereof will be omitted herein.

Major components of a conventional bait casting reel will now be described with reference to FIG. 1. FIG. 1 is a cross-sectional view illustrating the conventional bait casting reel.

Referring to FIG. 1, the bait casting reel includes a spool shaft 5 and a pinion 40 supported by a yoke 30. The yoke 30 is adapted to partially enclose a recessed portion formed at a circumference of the pinion. A considerable frictional force is generated between an upper surface of the yoke and the pinion, so that abrasion happens in frictional surfaces and thus the bait casting reel fails early. A major factor of the abrasion is that the yoke is made of plastic while the pinion is made of metal.

In order to solve the above problem, a metal yoke has been proposed. In this case, serious friction sound is produced by contact between a lower surface of the yoke and the pinion.

### SUMMARY OF THE INVENTION

Accordingly, the present invention is directed to a bait casting reel that substantially obviates one or more problems due to limitations and disadvantages of the related art.

An object of the present invention is to provide a bait casting reel capable of preventing abrasion of frictional surfaces of pinion and yoke which are to control transfer of rotatory force from a spool shaft to improve durableness of the bait casting reel and prevent malfunction thereof.

To achieve the object and other advantages, according to one aspect of the present invention, there is provide a bait casting reel including a pinion receiving a spool shaft and a yoke made of a synthetic resin for engaging/disengaging the pinion with/from the spool shaft, the bait casting reel comprising: a metal insert coupled to an upper surface of the yoke to prevent the yoke from being worn, in which the upper surface contacted with the pinion.

The present invention has an advantage in that since the yoke is made of a synthetic resin, it is possible to prevent friction sound from being produced due to contact between a lower surface of the yoke and the pinion.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a cross-sectional view of a conventional bait casting reel;

FIG. 2a is a partially cross-sectional view illustrating a state where a spool shaft is released from a pinion in a bait casting reel according to one preferred embodiment of the present invention;

FIG. 2b is a partially cross-sectional view illustrating a state wherein a spool shaft is engaged to a pinion in a bait casting reel according to one preferred embodiment of the present invention;

FIG. 3 is an exploded perspective view of a bait casting reel according to one preferred embodiment of the present invention; and

FIG. 4 is a perspective view illustrating a relationship between a yoke and a pinion.

### DETAILED DESCRIPTION OF PREFERRED EMBODIMENTS

A preferred embodiment according to the present invention will now be explained with reference to the accompanying drawings.

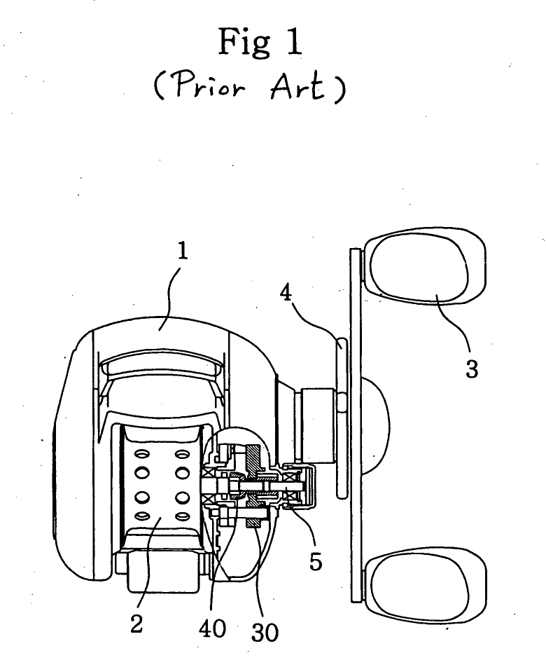

Referring to FIG. 1, a bait casting reel according to one preferred embodiment of the present invention includes a body 1 and a spool shaft 5 inserted into the body 1. On an upper surface of the body, a clutch cam 10, a cam plate 20, a yoke 30, a pinion 40 and a spring 50 are installed. According to one feature of the present invention, a metal insert 35 is coupled to an upper surface of the yoke 30. The yoke 30 is moved up and down by the clutch cam 10 and the cam plate 20. The pinion 40 is also moved in conjunction with the yoke 30.

Specifically, with the arrangement, if the clutch cam 10 rotates within a limited range, the pinion 40 is upwardly moved by the yoke 30, so that the spool shaft 5 is disengaged from the pinion 40. If the clutch cam 10 rotates in a reverse direction, the yoke 30 is downwardly moved by means of the spring 50, so that the pinion engages with the spool shaft.

Abrasion and friction sound are produced at contacted surfaced of the yoke 30 and the pinion 40 by the repeated process. FIG. 4 is a perspective view illustrating a relationship between the contacted surfaces of the yoke and pinion.

Because an upper surface of the yoke 30 is worn by the pinion 40, a metal insert 35 is coupled to the upper surface of the yoke 30 to prevent the abrasion. As shown in FIG. 3, the yoke 30 is previously formed of a synthetic resin by injection molding, and the insert 35 is attached to the upper surface of the yoke by means of an adhesive. Alternatively, the yoke may be integrally formed with the insert during the injection molding.

Since the metal insert is coupled to the yoke, it can prevent the abrasion of the yoke due to the mutual contact.

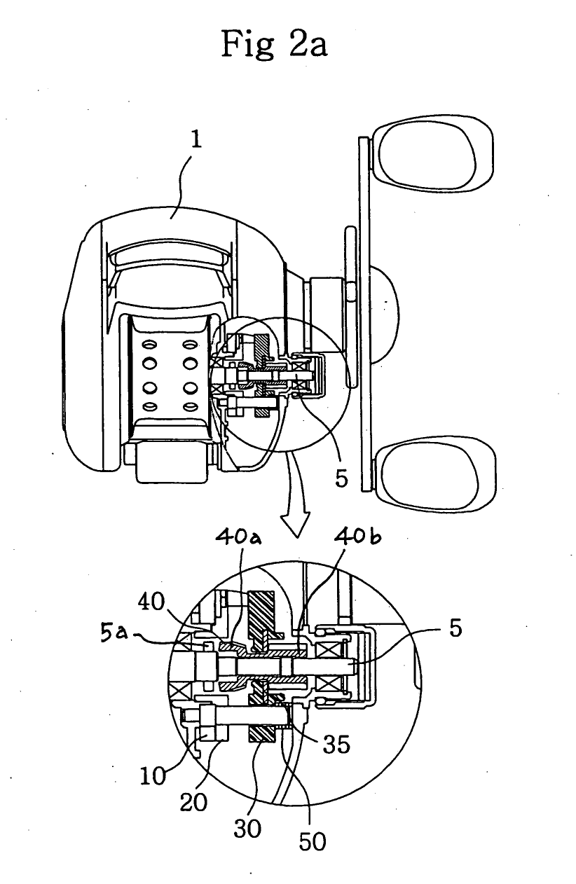

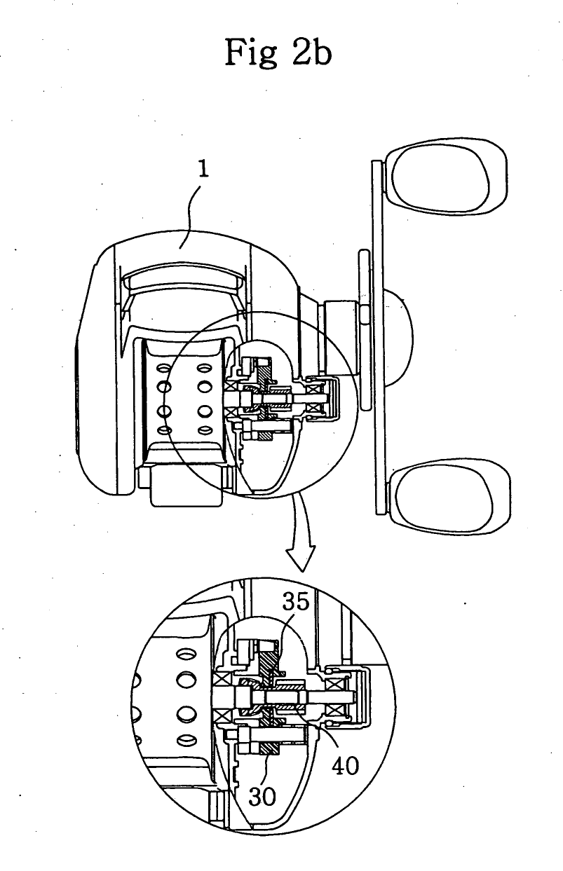

As shown in FIG. 2b, in the state the pinion 40 is engaged to the spool shaft 5, a lower surface of the yoke 30 is contacted with the pinion 40. Although the yoke is rubbed against the pinion, since the yoke is made of a synthetic resin, the friction sound is remarkably reduced.

With the arrangement of the present invention, it is possible to prevent the upper surface of the yoke from being worn, and to reduce the friction sound produced from the lower surface of the yoke.

The forgoing embodiments are merely exemplary and are not to be construed as limiting the present invention. The present teachings can be readily applied to other types of apparatus. The description of the present invention is intended to be illustrative, and not to limit the scope of the claims. Many alternatives, modifications, and variations will be apparent to those skilled in the art.

1. A bait casting reel comprising:
a spool shaft disposed in a body of the bait casting reel;
a pinion having a head portion and a shaft portion, the pinion slidably arranged on the spool shaft;
a yoke made of a synthetic resin, the yoke being moveable on the shaft portion of the pinion in one direction such that the yoke pushes the pinion for engaging the pinion with the spool shaft and in the other direction such that the yoke pulls the pinion for disengaging the pinion from the spool shaft; and
a metal insert coupled to the yoke only at a surface facing the other direction of the yoke for disengaging the pinion from the spool shaft to prevent the yoke from being worn by frictional contacts of the yoke with the pinion.

2. The bait casting reel of claim 1, further comprising a cam for moving the yoke along the shaft portion of the pinion in the other direction.

3. The bait casting reel of claim 2, further comprising a spring for moving the yoke along the shaft portion of the pinion in the one direction.

4. The bait casting reel of claim 1, wherein the metal insert is coupled to the yoke by attaching the metal insert to the yoke with an adhesive.

5. The bait casting reel of claim 1, wherein the metal insert is coupled to the yoke by integrally forming the metal insert with the yoke by injection molding.
